(19) United States
(12) Patent Application Publication
(10) Pub. No.: US 2021/0064195 A1
(43) Pub. Date: Mar. 4, 2021

(54) MULTI-DIMENSIONAL WATERFALL VISUALIZATION

(71) Applicant: BUSINESS OBJECTS SOFTWARE LTD., Dublin (IE)

(72) Inventors: Yijian Wang, Richmond (CA); Nan Xuan Wang, Surrey (CA)

(21) Appl. No.: 16/560,290

(22) Filed: Sep. 4, 2019

(51) Int. Cl. G06F 3/0482; G06F 16/901; G06F 16/904; G06Q 40/00

(52) U.S. Cl. CPC G06F 3/0482; G06Q 40/12; G06F 16/904; G06F 16/9024

(57) ABSTRACT

A system includes reception of a selection of a first dimension and a measure, reception of a selection of a second dimension, determination of an aggregation of the measure over each of a plurality of dimension members of the first dimension, determination, for each of the plurality of aggregations, of a breakdown of the aggregation over a plurality of dimension members of the second dimension, and presentation of a visualization of each of the plurality of aggregations and each of the plurality of breakdowns of each of the plurality of aggregations.

### BACKGROUND

Enterprise software systems receive, generate, and store data related to many aspects of an enterprise. Users operate reporting tools to access such data and display the data in useful formats, such as in graphic visualizations. Specifically, a reporting tool may query a backend data source, receive a corresponding result set from the backend data source, and present a visualization of the result set.

A waterfall chart is a type of visualization which shows how a measure value (e.g., Revenue) is broken down into dimension members (e.g., 2013, 2014) of a primary dimension (e.g., Time). Visualization systems are desired which efficiently illustrate additional breakdown information of the measure values associated with the dimension member of a primary dimension.

A waterfall chart may be presented in variance mode, in which the breakdown of measure values is illustrated using delta values which sum to a total difference between a starting and ending measure value. Conventionally, a user invokes variance mode by filtering out the root node of the primary dimension. Such a filtering procedure is not intuitive, and may result in undesired changes to the result set as well as to the waterfall chart. Exiting variance mode is similarly non-intuitive.

A waterfall chart in variance mode shows delta values even if the chart reflects multiple measures and multiple roots on the primary dimension. However, if one or more of the measures already exist as delta values in the data model, the delta values which are calculated and presented in the waterfall chart (i.e., delta values of delta values) will be incorrect/misleading. Systems are desired to improve user control over waterfall chart variance mode.

### BRIEF DESCRIPTION OF THE DRAWINGS

FIG. 1 is a view of a user interface to select data visualization metadata and displaying a waterfall visualization.

FIG. 2 illustrates a tree structure representing the data points of the FIG. 1 waterfall visualization.

FIG. 3 is a view of a user interface to select data visualization metadata including a measure and two dimensions, and displaying a corresponding waterfall visualization according to some embodiments.

FIG. 4 illustrates a tree structure representing the data points of the FIG. 3 waterfall visualization.

FIG. 5 is a flow diagram of a process to present a waterfall visualization according to some embodiments.

FIG. 6 is a block diagram of a system to provide data visualizations according to some embodiments.

FIG. 7 illustrates operation of a user interface to request expansion of a breakdown dimension member of a waterfall visualization according to some embodiments.

FIG. 8 illustrates a tree structure representing a hierarchy of dimension members of a breakdown dimension according to some embodiments.

FIG. 9 illustrates a tree structure representing the data points of the FIG. 10 waterfall visualization.

FIG. 10 illustrates a waterfall visualization including an expanded breakdown dimension member according to some embodiments.

FIG. 11 is a flow diagram of a process to present a waterfall visualization including an expanded breakdown dimension member according to some embodiments.

FIG. 12 illustrates operation of a user interface to request expansion of a primary dimension member of a waterfall visualization according to some embodiments.

FIG. 13 illustrates a tree structure representing the data points of the FIG. 14 waterfall visualization.

FIG. 14 illustrates a waterfall visualization including an expanded breakdown dimension member and an expanded primary dimension member according to some embodiments.

FIG. 15 illustrates a waterfall visualization and an interface control for hiding a root node according to some embodiments.

FIG. 16 illustrates a tree structure representing the data points of the FIG. 15 waterfall visualization.

FIG. 17 illustrates a waterfall visualization in variance mode according to some embodiments.

FIG. 18 illustrates a tree structure representing the data points of the FIG. 17 waterfall visualization.

FIG. 19 illustrates a waterfall visualization in variance mode and including multiple measures according to some embodiments.

FIG. 20 illustrates a waterfall visualization including multiple measures and with variance mode deactivated according to some embodiments.

FIG. 21 illustrates a tree structure representing the data points of the FIG. 20 waterfall visualization.

FIG. 22 is a block diagram of an apparatus according to some embodiments.

### DETAILED DESCRIPTION

The following description is provided to enable any person in the art to make and use the described embodiments. Various modifications, however, will remain readily apparent to those in the art.

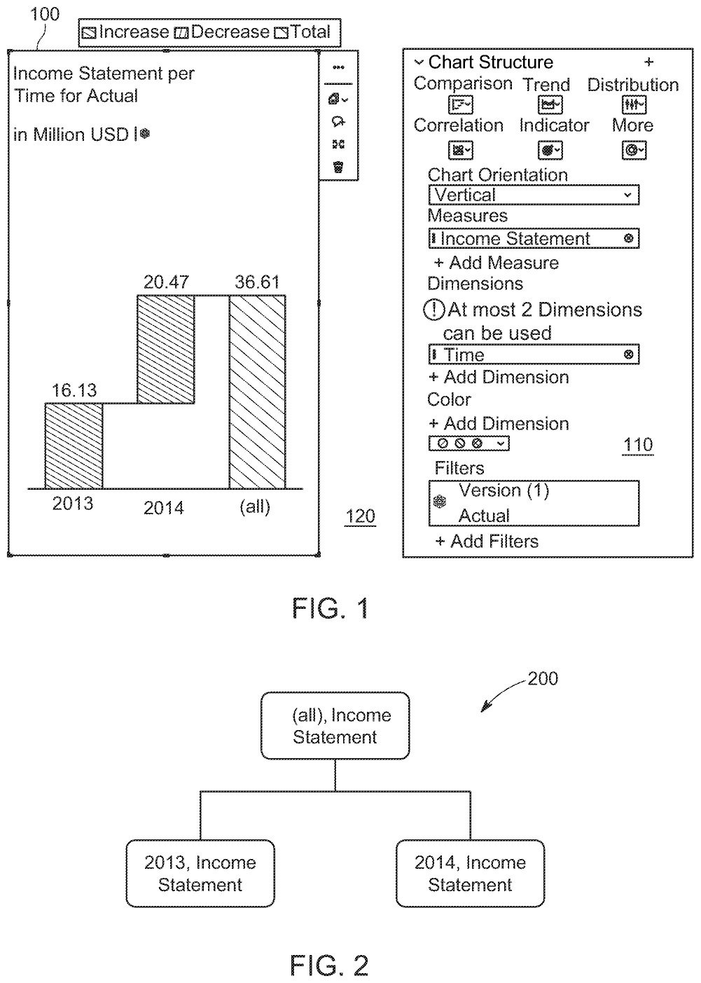

Generally, some embodiments provide a waterfall visualization including breakdown information on two different dimensions. FIG. 1 illustrates user interface 100 including query panel 110 for specifying metadata of a desired visualization as is known in the art. The specified metadata may include a data source, a visualization type, and dimensions, measures and/or filters of a data model, or schema, which characterizes the data stored in the data source. User interface 100 may be displayed by a client application executing on a client computing system, and the client computing system may communicate with a remote computing system to retrieve a result set associated with the specified metadata.

User interface 100 also includes visualization area 120 in which a requested visualization is presented. Visualization area 120 of FIG. 1 includes a waterfall visualization, in which the measure Income Statement is broken down over different dimension members (i.e., 2013, 2014) of the hierarchal Time dimension. In this example, Time is considered the primary dimension. FIG. 2 illustrates tree structure 200, where each node corresponds to an aggregation of the measure Income Statement which is presented in the waterfall visualization, and whose structure indicates how lower-level aggregations roll up into high-level aggregations. The client application may construct tree structure 200 to assist in generation of the backend queries needed to retrieve the data points to be presented by the waterfall visualization and generation of the physical layout of the waterfall visualization.

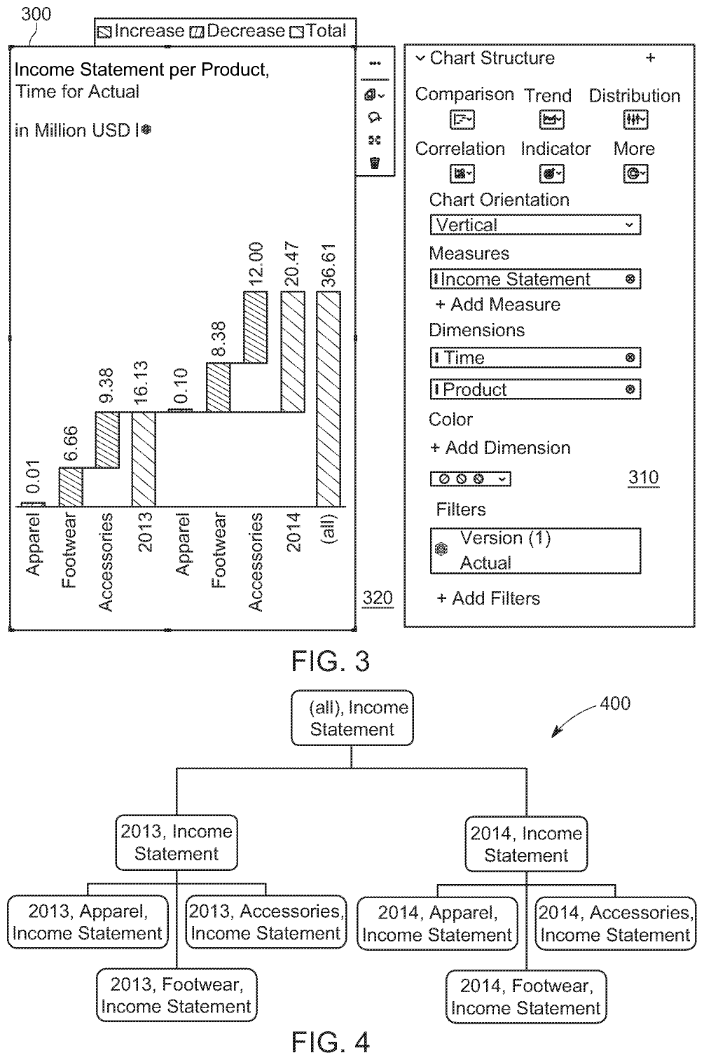

FIG. 3 illustrates user interface 300, in which the Product dimension has been added in query panel 310. Such a second dimension added to a waterfall chart will be referred to herein as a breakdown dimension. Since the first level of the Product dimension includes only one node, the waterfall displayed in visualization area 320 is further broken down into the second level of dimension members (i.e., Apparel, Footwear and Accessories). By adding the breakdown dimension to the waterfall chart, an additional level of breakdown information on different dimensions is visualized, which assists the understanding of how the breakdown dimension affects and contributes to the measure values on the primary dimension.

Generation of a waterfall visualization with two dimensions, a tree may be constructed on all the measures and the primary dimension as shown in FIG. 2. Once the breakdown dimension is added, it is determined whether the breakdown dimension is a hierarchical dimension with a single root. If so, the root is expanded to generate child nodes. The generated tree nodes are then added to each existing leaf node as shown in FIG. 4. Generation of the visualization is affected by the order in which the primary and breakdown dimensions are selected. For example, if the Product dimension was selected before the Time dimension, the second row of tree 400 would show apparel, footwear and accessories nodes, with a 2013 node and a 2014 node under each of the three second-row nodes.

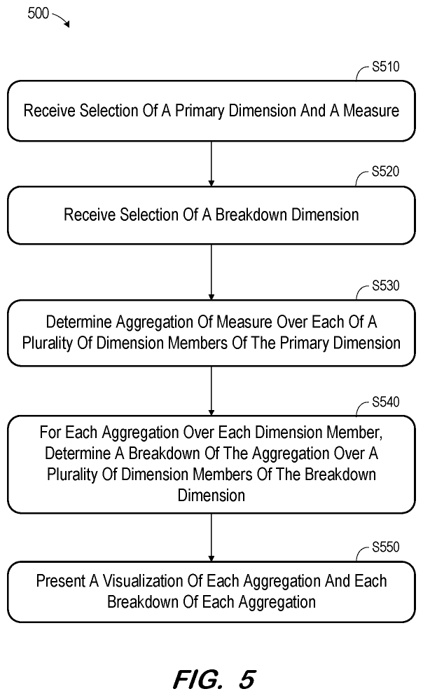

FIG. 5 comprises a flow diagram of process 400 to generate a waterfall visualization according to some embodiments. Process 400 and all other processes mentioned herein may be embodied in computer-executable program code read from one or more of non-transitory computer-readable media, such as a fixed disk drive, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

A selection of a primary dimension and a selection of a measure are received at S510. It will be assumed that S510 is preceded by a request to generate a waterfall visualization. According to some embodiments, the selections are received at S510 by a client application operated by a user. In one example, the client application presents user interface 300 and the user interacts with the UI controls of query panel 310 to select the primary dimension and the measure.

A selection of a breakdown dimension is received at S520. Selection of the breakdown measure may proceed similarly as the above-described selection of a primary dimension. Referring again to FIG. 3, the user may select a Product dimension in query panel 310 and the selection may be received by the client application at S520.

At S530, and in response to the selections received at S510 and S520, the client application determines an aggregation of the measure over each of a plurality of dimension members of the primary dimension. The aggregations of S530 are represented by the second-level nodes ((2013, Income Statement), (2014, Income Statement)) of tree 400. With respect to tree 400, the aggregations are 16.13 and 20.47, respectively.

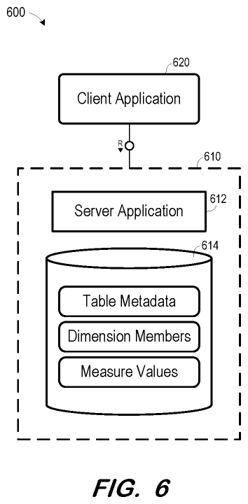

According to some embodiments, the client application determines the aggregations by sending a query associated with each aggregation to a backend system and receiving a result set corresponding to each query as is known in the art. An example of such a client-backend system will be described below with respect to FIG. 6.

At S540, and for each aggregation over each dimension member determined at S530, a breakdown of the aggregation is determined over each of a plurality of dimension members of the breakdown dimension. The aggregations of S540 are represented by the third-level nodes of tree 400. A visualization is then presented at S550, including each aggregation (e.g., 16.13, 20.47) determined at S530, and the breakdowns of each aggregation (e.g., 0.10, 6.66, 9.38 and 0.10, 8.38 and 12.00) determined at S540.

FIG. 3 depicts a visualization presented at S550 according to the present example. Visualization also includes an aggregation (i.e., 36.61) of the Income Statement measure over the entire Time dimension, represented by the root node of tree 400.

FIG. 6 is a block diagram of system architecture 600 according to some embodiments. Embodiments are not limited to system architecture 600 or to a database architecture.

Architecture 600 includes data server 610 and client application 620. Generally, data server 610 receives requests from client application 620 and provides results to client application 620 based on those requests. Server application 612 may be separated from or closely integrated with data store 614. Server application 612 may be executed completely on a database platform of data store 614, without the need for an additional server. Architecture 600 may be implemented using any client-server architecture that is or becomes known, including but not limited to on-premise, cloud-based and hybrid architectures.

In one specific example, client application 620 is executed to present a user interface to a user. The user defines a visualization using the user interface, and client application 620 generates and forwards requests based on the definition to server 610. Server application 612 generates SQL scripts based on the requests and forwards the SQL scripts to data store 614. Data store 614 executes the SQL scripts to return one or more result sets based on data of data store 614, and client application 620 generates and displays a visualization based on the result set.

Data store 614 stores table metadata, dimension members, and measure values. Generally, the table metadata defines one or more data models, each of which includes data objects such as dimension and measures. The stored dimension members and measure values comprise data representing actual (i.e., instantiated) versions of those objects. The table metadata also associates each measure and dimension with one or more physical entities (e.g., a physical database table, associated columns of one or more database tables).

The data of data store 614 may comprise one or more of conventional tabular data, row-based data, column-based data, and object-based data. Moreover, the data may be indexed and/or selectively replicated in an index to allow fast searching and retrieval thereof. Data store 614 may support multi-tenancy to separately support multiple unrelated clients by providing multiple logical database systems which are programmatically isolated from one another.

Data store 614 may comprise any query-responsive data source or sources that are or become known, including but not limited to a structured-query language (SQL) relational database management system. Data store 614 may comprise a relational database, a multi-dimensional database, an eXtendable Markup Language (XML) document, or any other data storage system storing structured and/or unstructured data. The data of data store 614 may be distributed among several relational databases, dimensional databases, and/or other data sources. Embodiments are not limited to any number or types of data sources.

Data store 614 may implement an “in-memory” database, in which a full database stored in volatile (e.g., non-disk-based) memory (e.g., Random Access Memory). The full database may be persisted in and/or backed up to fixed disks (not shown). Embodiments are not limited to an in-memory implementation. For example, data may be stored in Random Access Memory (e.g., cache memory for storing recently-used data) and one or more fixed disks (e.g., persistent memory for storing their respective portions of the full database).

Client application 620 may be executed by one or more devices executing program code of an application for presenting user interfaces to allow interaction with server 610. The user interfaces may be suited for reporting, data analysis, and/or any other functions based on the data of data store 614.

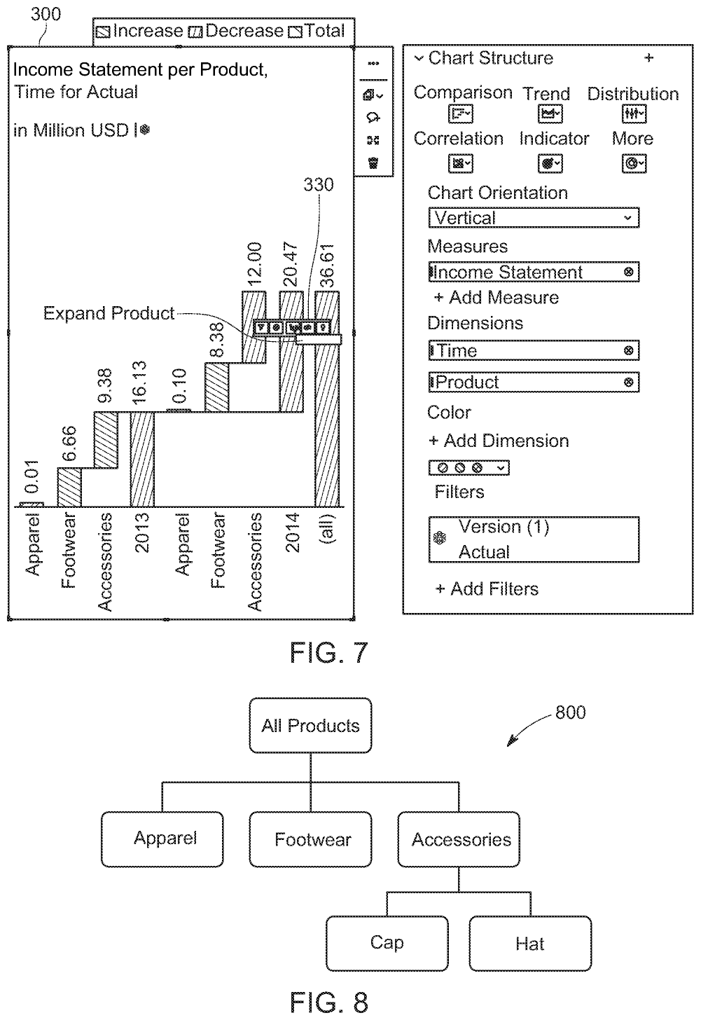

FIG. 7 illustrates a user instruction to expand the breakdown dimension according to some embodiments. In particular, the user may expand a node of the breakdown dimension if the node reflects a dimension member hierarchy. To prevent mixed expanding on measures, the primary dimension and the breakdown dimension, the user may be limited to expand the breakdown dimension on the nodes of breakdown dimension.

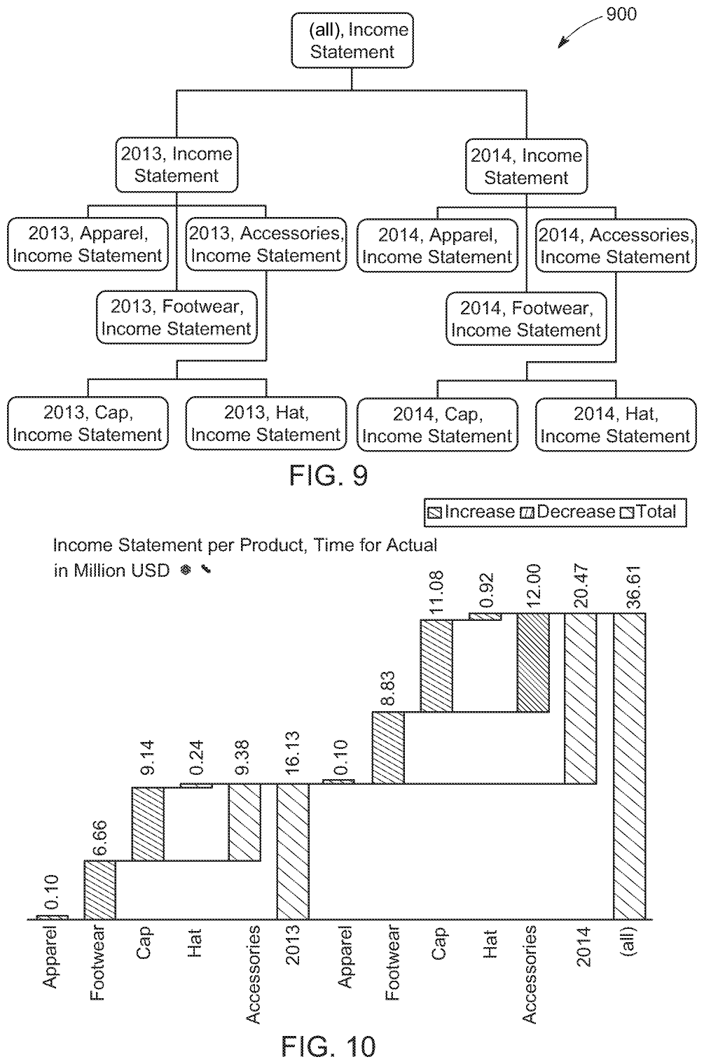

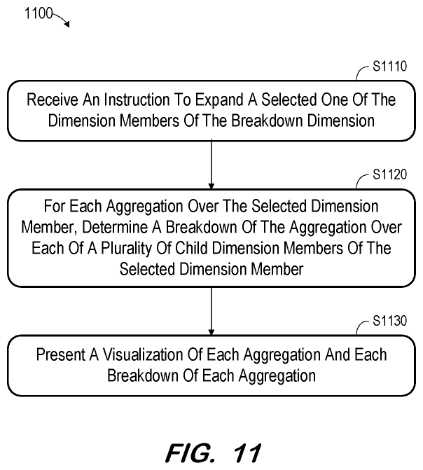

According to the present example, expanding on Accessories of the Product dimension results in generation of a subtree such as tree 800 of FIG. 8. The generated subtree is then added to each leaf node of the existing waterfall tree as shown in FIG. 9. FIG. 10 illustrates the resulting waterfall visualization, which presents the aggregations of Cap and Hat which compose the aggregations of Accessories.

FIG. 11 is a flow diagram of process 1100 to facilitate the expansion of the breakdown dimension according to some embodiments. Initially, at S1110, an instruction to expand a selected one of the dimension members of a breakdown dimension is received. The instruction may be received via a user interface of a client application as depicted in FIG. 7.

At S1120, and for each aggregation over the selected dimension member, a breakdown of the aggregation is determined over each of a plurality of child dimension members of the selected dimension member. With reference to the present example, the selected dimension member is Accessories and the current aggregations over Accessories are (2013, Accessories, Income Statement) and (2014, Accessories, Income Statement). Accordingly, breakdowns of these aggregations are determined over Cap and Hat at S1120, as represented by the leaf nodes of tree 900. A visualization of each aggregation of the selected dimension and each breakdown determined at S1120 is presented at S1130, as depicted in FIG. 10.

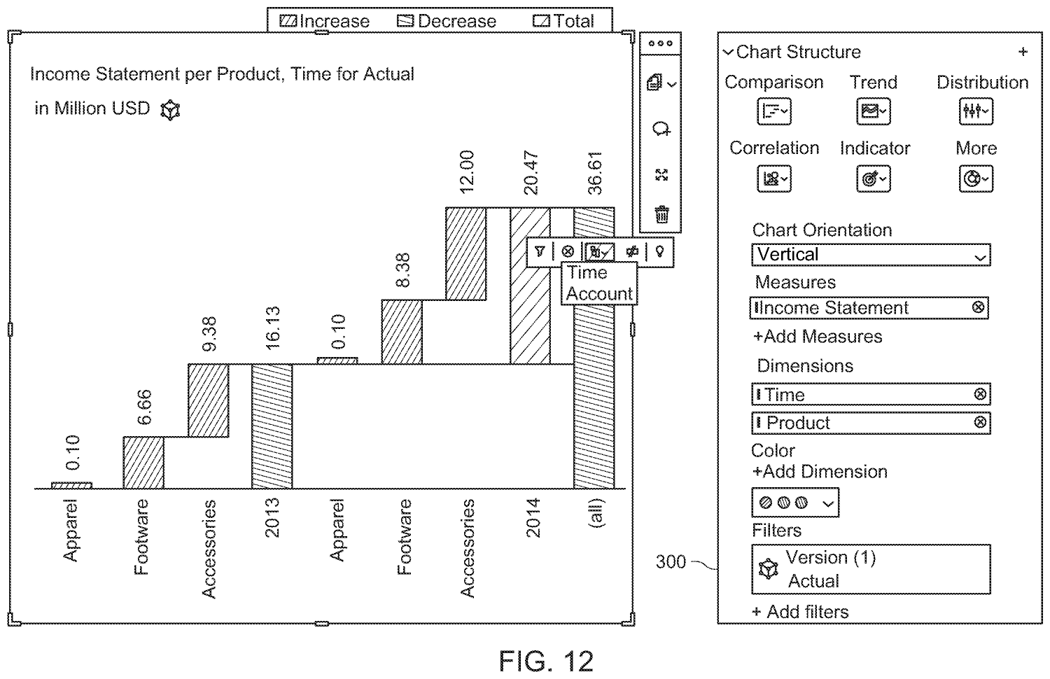

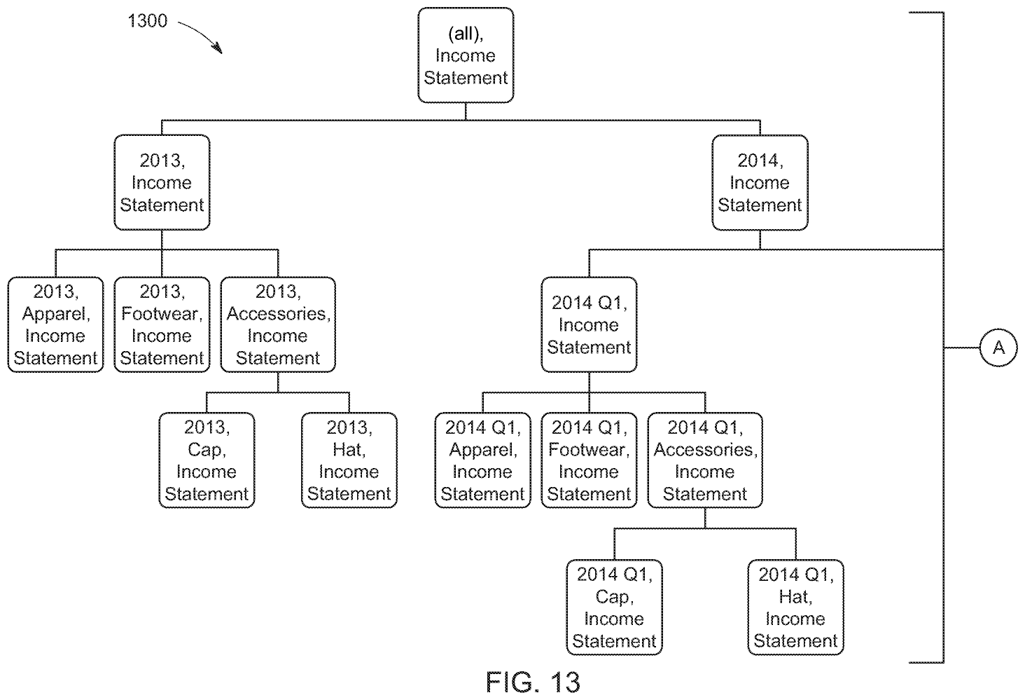

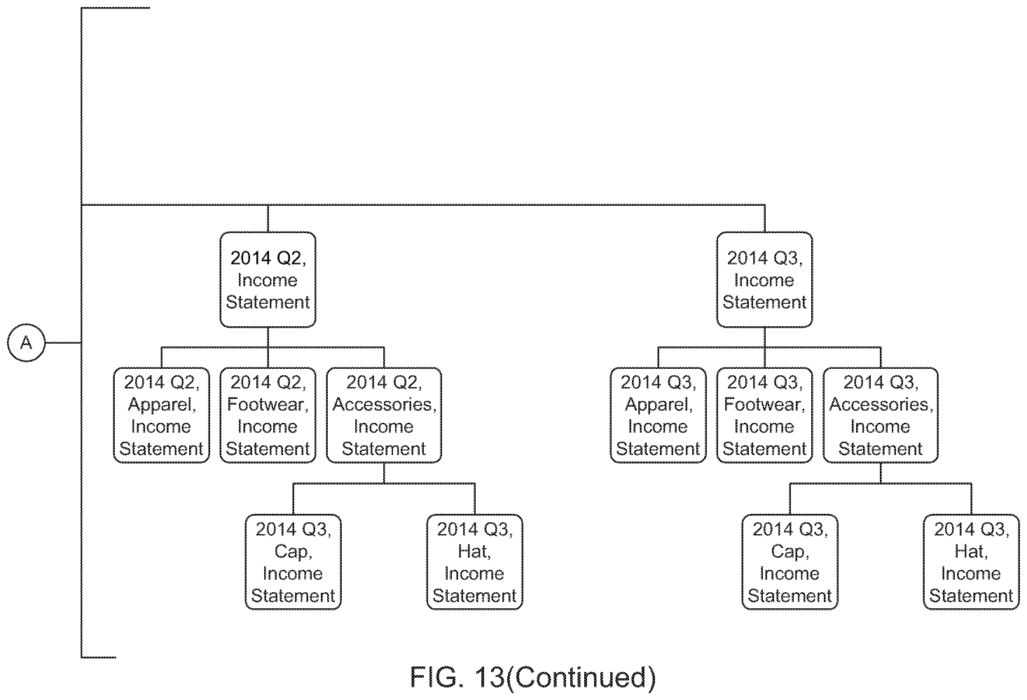

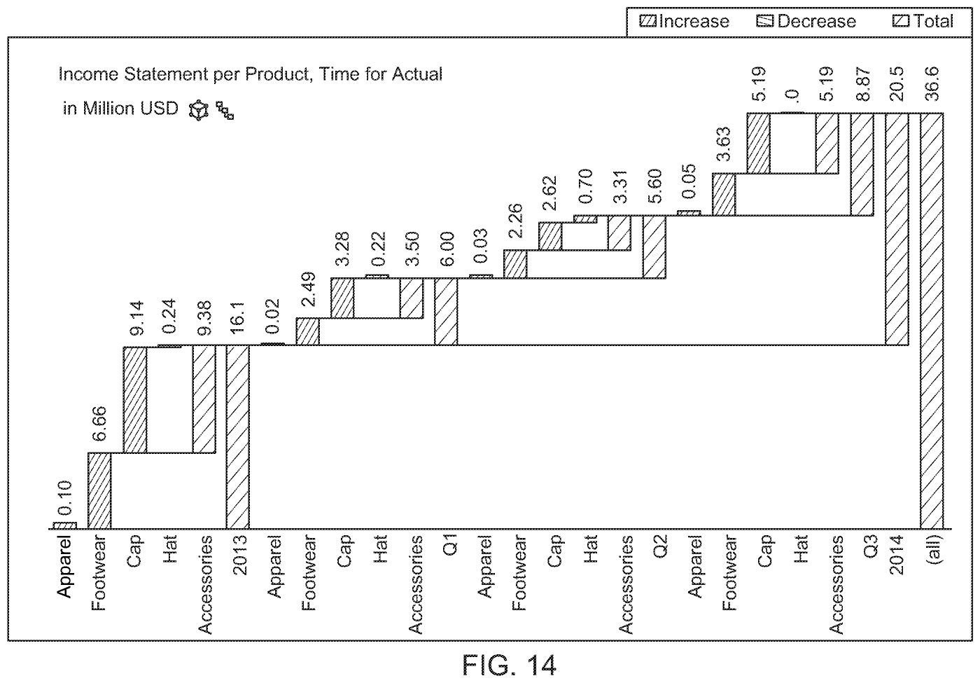

If a user submits instructions to expand on both the breakdown dimension and the primary dimension, the primary dimension is expanded first by constructing a corresponding waterfall tree. A subtree of the breakdown dimension is then added to the leaf nodes of waterfall tree as described above. For example, it is assumed that the user selects expansion on 2014 by selecting Time from control 340 of FIG. 12, and then selects expansion on Accessories of Product as described with respect to FIG. 7. The resulting waterfall tree is shown in FIG. 13, which corresponds to the waterfall visualization of FIG. 14.

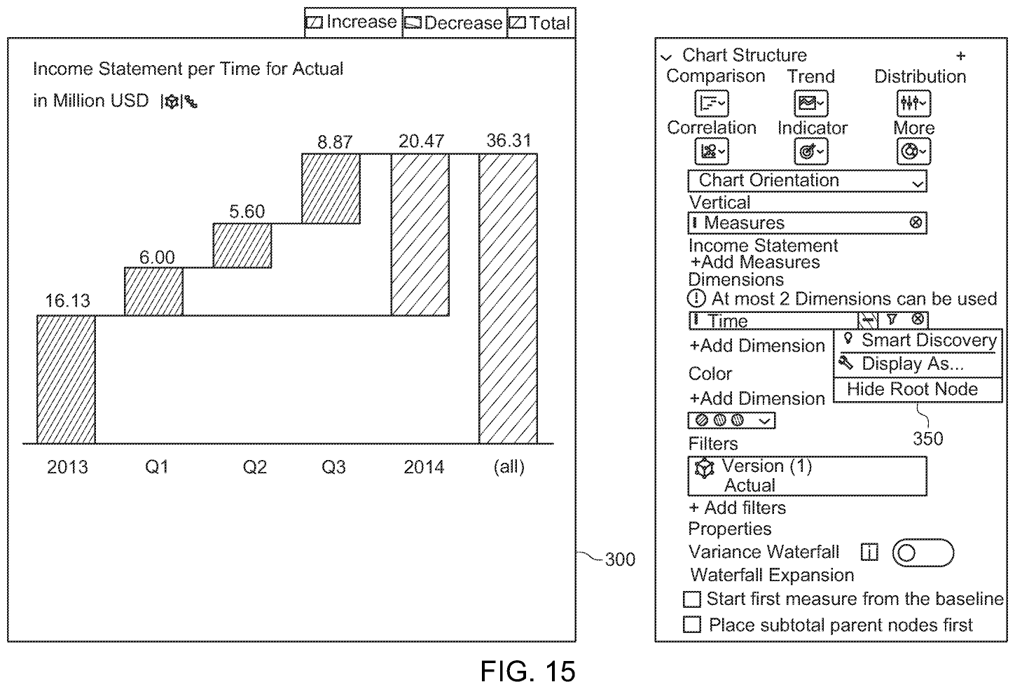

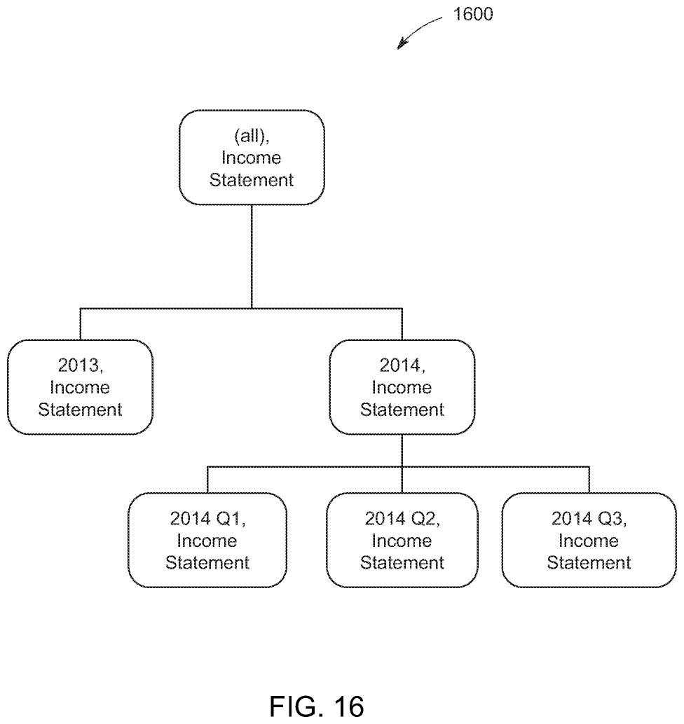

FIG. 15 illustrates a waterfall visualization for purposes of the foregoing discussion of variance mode. The waterfall visualization of FIG. 15 illustrates a breakdown of the measure Income Statement aggregated over 2014, with respect to dimension members 2014.Q1, 2014.Q2 and 2014.Q3. The corresponding tree structure 1600 is shown in FIG. 16.

As described above, variance mode illustrates a breakdown of measure values using delta values which sum to a total difference between a starting and ending measure value. Conventionally, a user invokes variance mode by filtering out the root node of the primary dimension. In contrast, user interface of FIG. 15 shows “Hide Root Node” control 350, which may be selected by a user to enter variance mode according to some embodiments. Selection of “Hide Root Node” control 350 therefore allows the user to hide the root node of primary dimension simply and without changing an associated filter.

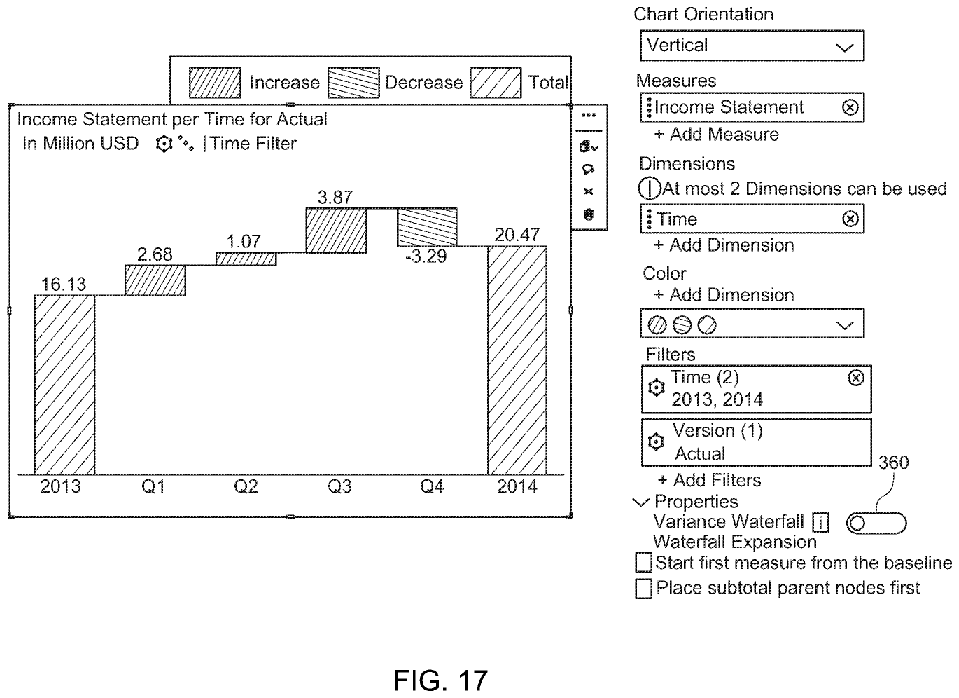

FIG. 17 depicts a waterfall visualization in variance mode and roughly corresponding to the waterfall visualization of FIG. 15. The FIG. 17 visualization includes delta values for each dimension member of the primary dimension. Tree structure 1800 reflects removal of the root node of the FIG. 16 tree structure. Moreover, each of the leaf nodes corresponding to the dimension members has been altered to represent differences between aggregations (i.e., delta values).

The “Hide Root Node” control is displayed for a given dimension if the dimension is the primary dimension of the waterfall visualization, is a hierarchical dimension, and has a single root. In response to an instruction to hide the root node, the child members of the root node are identified. If multiple members exist, the waterfall visualization enters variance mode and presents delta values instead of actual values.

Query panel 310 of FIG. 17 includes switch 360 to indicate whether or not the waterfall visualization is in variance mode. Switch 360 is disabled if only one measure is selected. However, if the waterfall visualization is in variance mode and includes multiple measures, switch 360 is enabled to allow the user to easily switch between actual values (non-variance mode) and delta values (variance mode). Switch 360 may be useful in a case that selected measures are delta value, so that calculation of delta values is not needed.

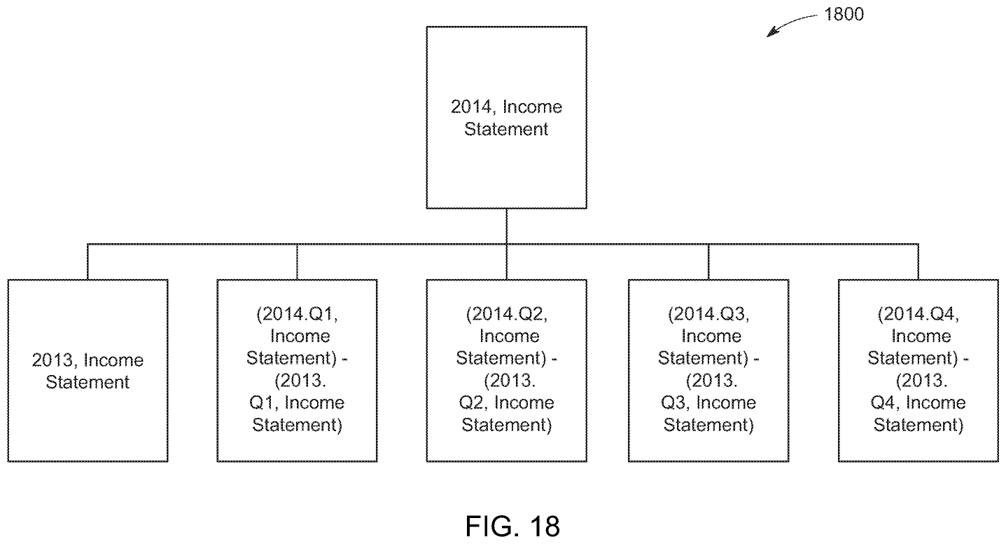

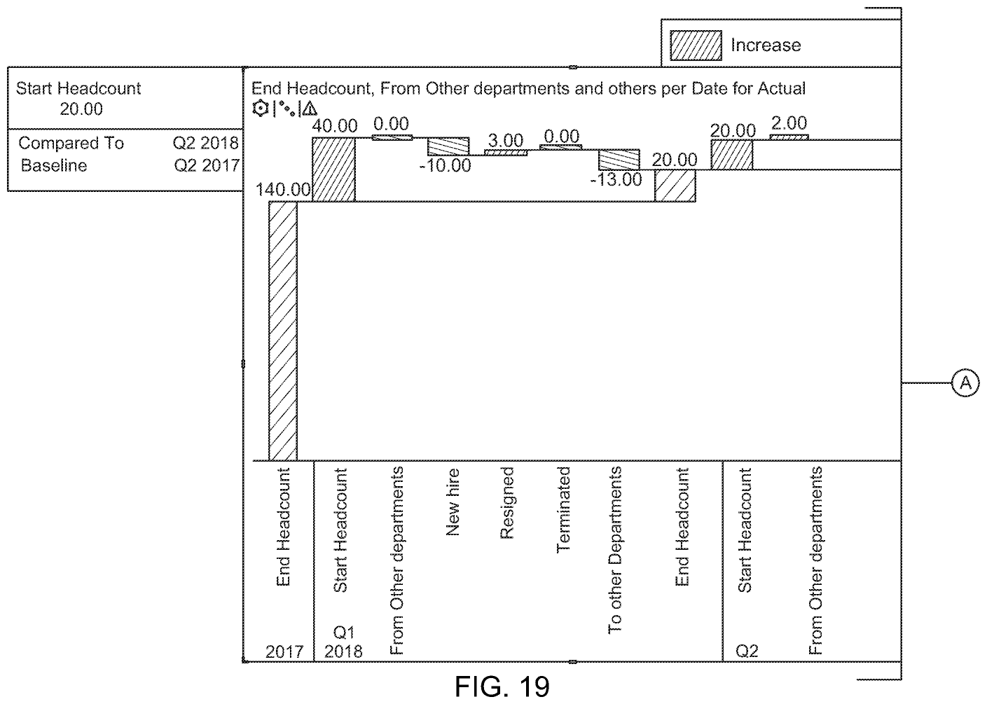

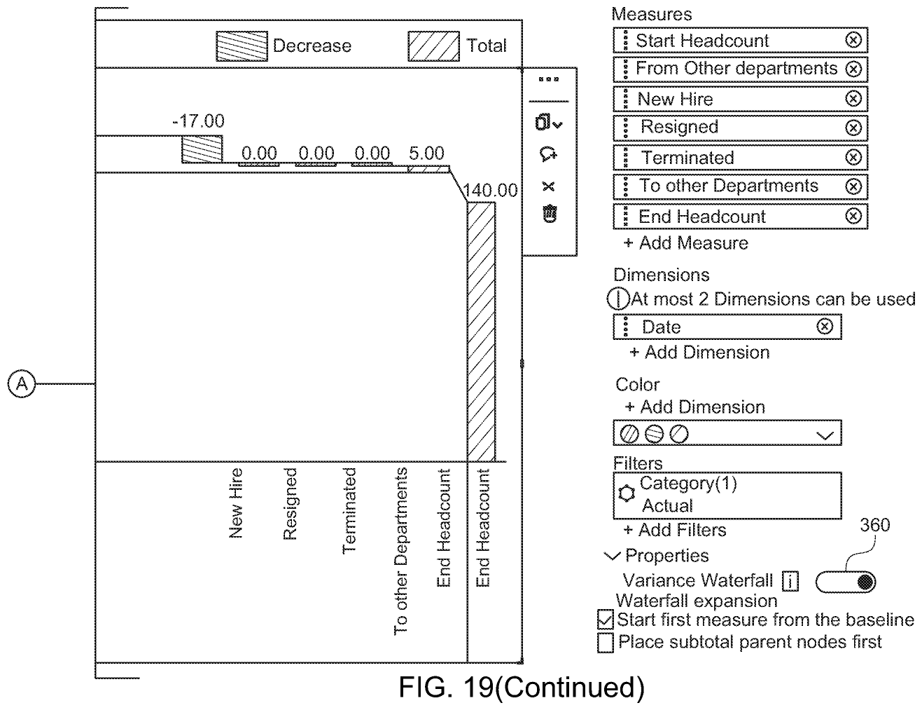

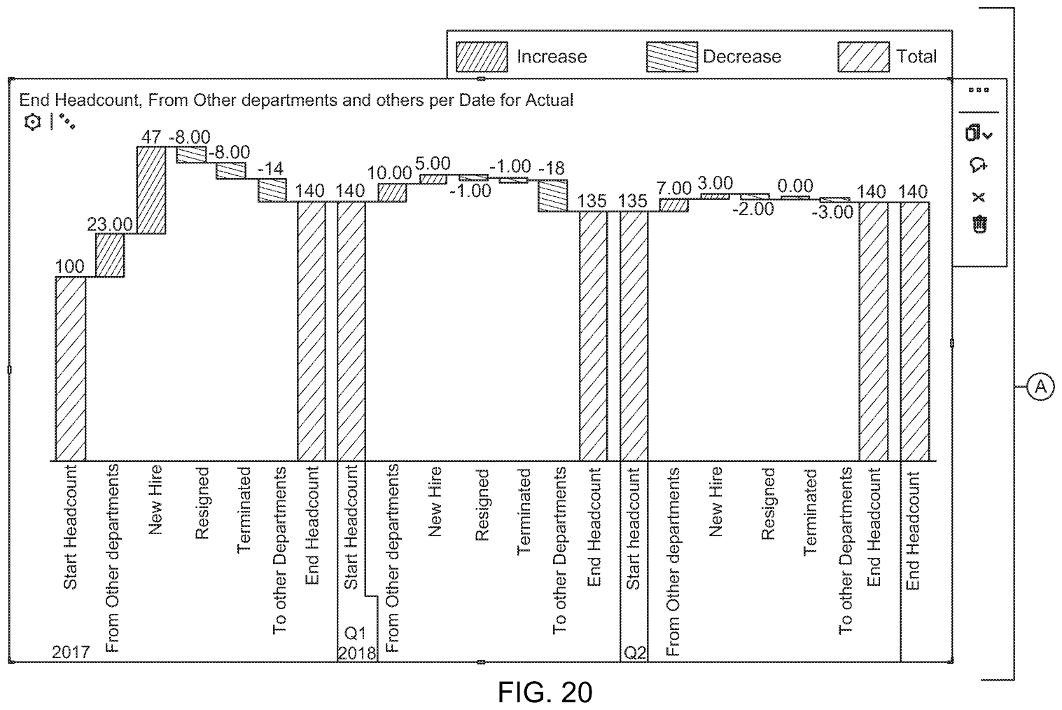

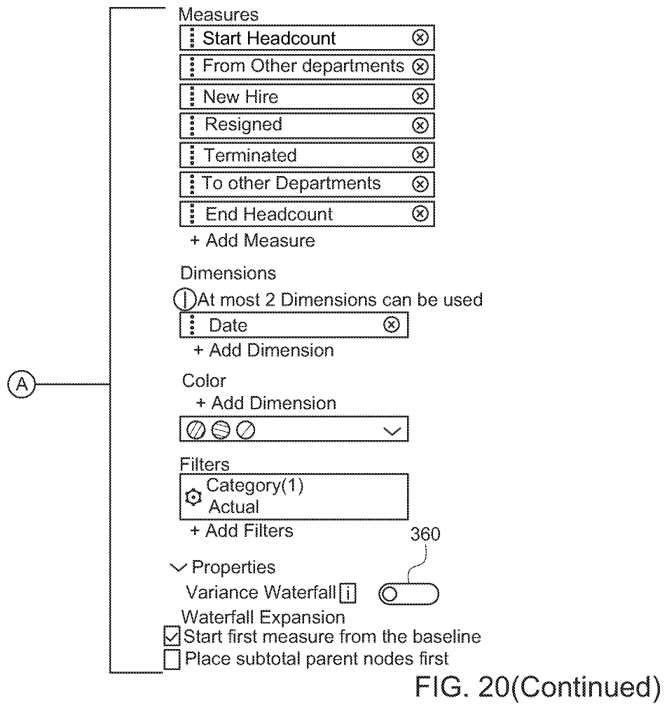

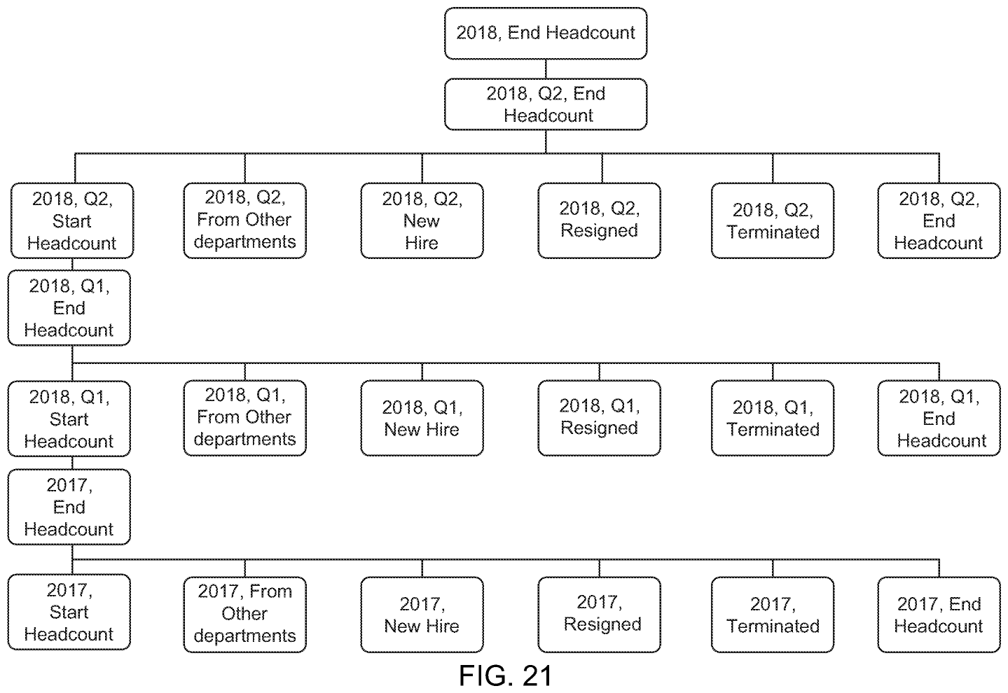

FIG. 18 illustrates a waterfall visualization including multiple measures and with switch 360 indicating that the visualization is in variance mode. Accordingly, the visualization shows delta values. FIG. 19 illustrates the FIG. 18 visualization after switch 360 has been turned off. The FIG. 19 visualization is therefore not in variance mode, and the illustrated measure values are actual values. For clarity, FIG. 20 shows tree structure 2000 representing the aggregations and breakdowns depicted in FIG. 19.

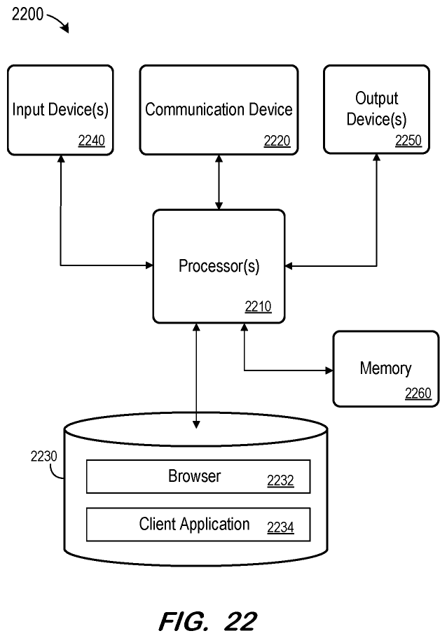

FIG. 22 is a block diagram of apparatus 2200 according to some embodiments. Apparatus 2200 may comprise a general-purpose computing apparatus and may execute program code to perform any of the functions described herein. Apparatus 2200 may comprise an implementation of a system to execute client application 620 as described above. Apparatus 2200 may include other unshown elements according to some embodiments.

Apparatus 2200 includes processor(s) 2210 operatively coupled to communication device 2220, data storage device 2230, one or more input devices 2240, one or more output devices 2250 and memory 2260. Communication device 2220 may facilitate communication with external devices, such as a reporting client, or a data storage device. Input device(s) 2240 may comprise, for example, a keyboard, a keypad, a mouse or other pointing device, a microphone, knob or a switch, an infra-red (IR) port, a docking station, and/or a touch screen. Input device(s) 2240 may be used, for example, to enter information into apparatus 2200. Output device(s) 2250 may comprise, for example, a display (e.g., a display screen) a speaker, and/or a printer.

Data storage device 2230 may comprise any appropriate persistent storage device, including combinations of magnetic storage devices (e.g., magnetic tape, hard disk drives and flash memory), optical storage devices, Read Only Memory (ROM) devices, etc., while memory 2260 may comprise Random Access Memory (RAM), Storage Class Memory (SCM) or any other fast-access memory.

Services 2231, server application 2232 and DBMS 2233 may comprise program code executed by processor 2210 to cause apparatus 2200 to perform any one or more of the processes described herein. Embodiments are not limited to execution of these processes by a single apparatus.

Browser 2232 may comprise program code to provide an execution engine, while client application 2234 may comprise program code executed by processor 2210 (and within the execution engine) to cause apparatus 2200 to perform any one or more of the processes described herein. Embodiments are not limited to execution of these processes by a single apparatus. Data storage device 2230 may also store data and other program code for providing additional functionality and/or which are necessary for operation of apparatus 2200, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a fixed disk drive, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

1. A computing system comprising:
a memory; and
a processor to execute processor-executable process steps of a client application to:
receive a selection of a first dimension and a measure;
receive a selection of a second dimension;
determine a plurality of aggregations, wherein each particular aggregation is of the measure over each of a plurality of dimension members of the first dimension;
for each particular aggregation of the plurality of aggregations, determine a plurality of breakdowns, each particular breakdown of the plurality of breakdowns being of the particular aggregation over a plurality of dimension members of the second dimension; and
present a waterfall visualization of each particular aggregation of the plurality of aggregations and each particular breakdown of the plurality of breakdowns of each of the plurality of aggregations, wherein the waterfall visualization comprises a chart showing first dimensional data of the first dimension along a first axis and second dimension data of the second dimension along a second axis, wherein the first axis is orthogonal to the second axis.

2. (canceled)

3. A computing system according to claim 1, the processor to execute processor-executable process steps of the client application to:
receive an instruction to expand a selected one of the dimension members of the second dimension;
for each aggregation over the selected dimension member, determine a breakdown of the aggregation over each of a plurality of child dimension members of the selected dimension member; and
present a visualization of each of the plurality of aggregations of the measure over each of a plurality of dimension members of the first dimension, each of the plurality of breakdowns of each of the plurality of aggregations of the measure over each of a plurality of dimension members of the first dimension, and each breakdown of each aggregation over the selected dimension member of the second dimension.

4. A computing system according to claim 1, the processor to execute processor-executable process steps of the client application to:
present a user interface switch to convert the visualization to a variance mode;
in response to selection of the user interface switch:
determine a first difference between a breakdown of a first aggregation over a first of the plurality of dimension members and a breakdown of a second aggregation over the first of the plurality of dimension members by subtracting a second aggregation value of the second aggregation over the first of the plurality of dimension members from the first aggregation value of the first aggregation over the first of the plurality of dimension members; and
determine a second difference between a breakdown of the first aggregation over a second of the plurality of dimension members and a breakdown of the second aggregation over the second of the plurality of dimension members by subtracting a second aggregation value of the second aggregation over the second of the plurality of dimension members from the first aggregation value of the first aggregation over the second of the plurality of dimension members; and
present a second visualization of each of the plurality of aggregations, the first difference and the second difference.

5. A computing system according to claim 4, the processor to execute processor-executable process steps of the client application to:
present a second user interface switch to exit the variance mode; and
in response to selection of the second user interface switch, present a third visualization of each of the plurality of aggregations and each of the plurality of breakdowns of the second aggregation.

6. A computing system according to claim 5, wherein the second user interface switch is enabled only if the second visualization is associated with two or more measures.

7. A computing system according to claim 5, wherein the third visualization does not comprise any breakdowns of the first aggregation.

8. A method for a client application executing on a client device, the method comprising:
presenting a user interface;
receiving, via the user interface, a selection of a first dimension and a measure;
receiving, via the user interface, a selection of a second dimension;
determining a plurality of aggregations, wherein each particular aggregation is of the measure over each of a plurality of dimension members of the first dimension;
for each particular aggregation of the plurality of aggregations, determining plurality of breakdowns, each particular breakdown of the plurality of breakdowns being of the particular aggregation over a plurality of dimension members of the second dimension; and
presenting, on the user interface, a waterfall visualization of each particular aggregation of the plurality of aggregations and each particular breakdown of the plurality of breakdowns of each of the plurality of aggregations, wherein the waterfall visualization comprises a chart showing first dimensional data of the first dimension along a first axis and second dimension data of the second dimension along a second axis, wherein the first axis is orthogonal to the second axis.

9. (canceled)

10. A method according to claim 8, further comprising:
receive an instruction to expand a selected one of the dimension members of the second dimension;
for each aggregation over the selected dimension member, determine a breakdown of the aggregation over each of a plurality of child dimension members of the selected dimension member; and
present a visualization of each of the plurality of aggregations of the measure over each of a plurality of dimension members of the first dimension, each of the plurality of breakdowns of each of the plurality of aggregations of the measure over each of a plurality of dimension members of the first dimension, and each breakdown of each aggregation over the selected dimension member of the second dimension.

11. A method according to claim 8, further comprising:
presenting, on the user interface, a user interface switch to convert the visualization to a variance mode;
receiving a selection of the user interface switch;
in response to the selection of the user interface switch:
determining a first difference between a breakdown of a first aggregation over a first of the plurality of dimension members and a breakdown of a second aggregation over the first of the plurality of dimension members by subtracting a second aggregation value of the second aggregation over the first of the plurality of dimension members from the first aggregation value of the first aggregation over the first of the plurality of dimension members; and
determining a second difference between a breakdown of the first aggregation over a second of the plurality of dimension members and a breakdown of the second aggregation over the second of the plurality of dimension members by subtracting a second aggregation value of the second aggregation over the second of the plurality of dimension members from the first aggregation value of the first aggregation over the second of the plurality of dimension members; and
presenting a second visualization of each of the plurality of aggregations, the first difference and the second difference.

12. A method according to claim 11, further comprising:
presenting, on the user interface, a second user interface switch to exit the variance mode;
receiving a selection of the second user interface switch; and
in response to selection of the second user interface switch, presenting a third visualization of each of the plurality of aggregations and each of the plurality of breakdowns of the second aggregation.

13. A method according to claim 12, wherein the second user interface switch is enabled only if the second visualization is associated with two or more measures.

14. A method according to claim 12, wherein the third visualization does not comprise any breakdowns of the first aggregation.

15. A non-transitory computer-readable medium having instructions stored thereon which are executable by a computing device to:
process a received selection of a first dimension and a measure;
process a received selection of a second dimension;
determine a plurality of aggregations, wherein each particular aggregation is of the measure over each of a plurality of dimension members of the first dimension;
for each particular aggregation of the plurality of aggregations, determine a plurality of breakdowns, each particular breakdown of the plurality of breakdowns being of the particular aggregation over a plurality of dimension members of the second dimension; and
present a waterfall visualization of each particular aggregation of the plurality of aggregations and each particular breakdown of the plurality of breakdowns of each of the plurality of aggregations, wherein the waterfall visualization comprises a chart showing first dimensional data of the first dimension along a first axis and second dimension data of the second dimension along a second axis, wherein the first axis is orthogonal to the second axis.

16. The computer-readable medium according to claim 15, wherein the instructions are further executable by the computing device to:
process a received instruction to expand a selected one of the dimension members of the second dimension;
for each aggregation over the selected dimension member, determine a breakdown of the aggregation over each of a plurality of child dimension members of the selected dimension member; and
present a visualization of each of the plurality of aggregations of the measure over each of a plurality of dimension members of the first dimension, each of the plurality of breakdowns of each of the plurality of aggregations of the measure over each of a plurality of dimension members of the first dimension, and each breakdown of each aggregation over the selected dimension member of the second dimension.

17. The computer-readable medium according to claim 15, wherein the instructions are further executable by the computing device to:
present a user interface switch to convert the visualization to a variance mode;
in response to selection of the user interface switch:
determine a first difference between a breakdown of a first aggregation over a first of the plurality of dimension members and a breakdown of a second aggregation over the first of the plurality of dimension members by subtracting a second aggregation value of the second aggregation over the first of the plurality of dimension members from the first aggregation value of the first aggregation over the first of the plurality of dimension members; and
determine a second difference between a breakdown of the first aggregation over a second of the plurality of dimension members and a breakdown of the second aggregation over the second of the plurality of dimension members by subtracting a second aggregation value of the second aggregation over the second of the plurality of dimension members from the first aggregation value of the first aggregation over the second of the plurality of dimension members; and
determine a second visualization of each of the plurality of aggregations, the first difference and the second difference.

18. The computer-readable medium according to claim 17, wherein the instructions are further executable by the computing device to:
present a second user interface switch to exit the variance mode; and
in response to selection of the second user interface switch, present a third visualization of each of the plurality of aggregations and each of the plurality of breakdowns of the second aggregation.

19. A computing system according to claim 18, wherein the second user interface switch is enabled only if the second visualization is associated with two or more measures.

20. A computing system according to claim 18, wherein the third visualization does not comprise any breakdowns of the first aggregation.
